(19) United States
(12) Patent Application Publication
(10) Pub. No.: US 2010/0119987 A1
(43) Pub. Date: May 13, 2010

(54) Method of Treating Residual Caries

(75) Inventor: Steven D. Jensen, South Jordan, UT (US)

Correspondence Address: CAO Group, Inc., 4628 W. Skyhawk Drive, West Jordan, UT, 84084, US

(73) Assignee: CAO GROUP, INC., West Jordan, UT (US)

(21) Appl. No.: 12/563,223

(22) Filed: Sep. 21, 2009

Related U.S. Application Data
(63) Continuation-in-part of application No. 11/759,784, filed on Jun. 7, 2007, now abandoned.
Application No. 11/759,784 is a continuation-in-part of application No. 11/423,424, filed on Jun. 9, 2006, now abandoned.
Application No. 11/423,424 is a continuation of application No. 12/555,692, filed on Sep. 8, 2009.

(51) Int. Cl. A61C 17/00

(52) U.S. Cl. 433/29; 433/216

(57) ABSTRACT

The present invention is a method of treating residual caries utilizing a matched laser and dye combination. After initial preparation and excavation of a caries site, a dye is flooded into the site which stains areas of residual caries. A laser with a complimentary wavelength is then used to ablate stained areas. Since healthy dental tissue will not receive the dye and allow staining, diseased tissue will be the only tissue that is stained, not only providing a visual indicator, but also providing a more efficient surface to receive laser energy and allow for more efficient ablation of the compromised tissue. According to the method, the dye may contain and enhancing, oxidizing compound or an anesthetic, and surrounding tissues may be protected by the use of substances opaque to the radiant energy. Indocyanine green has shown particular effectiveness as a dye in this and related methods.

### CROSS-REFERENCES TO RELATED APPLICATIONS

The present Application claims priority as a continuation-in-part application of prior U.S. application Ser. No. 11/759,784, filed Jun. 7, 2007, which is in turn a continuation-in-part application of prior U.S. application Ser. No. 11/423,424, filed Jun. 6, 2006. It is also a continuing-in-part application of prior filed U.S. application Ser. No. 12/555,692, filed Sep. 8, 2009. All three applications being incorporated herein by reference.

### FIELD OF THE INVENTION

The present invention relates to the field of dental treatments and more particularly relates to a method of treating residual caries with a dye and matched laser.

### BACKGROUND OF THE INVENTION

Caries treatment in the prior art is a conceptually simple procedure—a practitioner, usually a dentist, excavates a caries site to remove diseased and decayed tissue and then refills the site with a substitute. Location of the site is usually a simple task as decay may either be visually or radio-graphically identified. Recently, excavation methods have utilized a laser to ablate the area and remove decayed tissue. While decayed tissue and bacterial waste usually leave a brownish or black coloration (resulting in easy absorption of laser energy), healthy hard tissue (i.e. tooth or bone) is usually white, causing a reflection of laser energy and a tendency to be more resistant to laser destruction that decayed tissue.

Excavation usually stops when no more decayed tissue is visually detected; however, some compromised hard tissue and decay causing bacteria usually remains. Because of this fact, a practitioner usually excavates beyond what is visually detectable, without regard as to the health of this extra hard tissue as the practitioner has no idea as to how healthy the extra hard tissue is. This fact has led to the development of caries detectors—dyes used to quickly flush an excavated area, which are retained by more porous decayed dental tissue and therefore leave a more readily identifiable target for further excavation. Unfortunately, in order to remove this detected decayed tissue, a disproportionate amount of healthy surrounding hard tissue must also be removed. Some prior art has suggested using a photosensitizing material and allowing bacteria to absorb said material before then irradiating it with a laser as a means to sanitize the site, but this method is limited to surface effectiveness and cannot reach bacteria hidden in layers of diseased tissue. This does not address the problem of identifying and eliminating compromised and/or decayed residual hard tissue.

The present invention is a method using a laser to ablate tissue identified by a specific dye chosen to match the wavelength of the laser to increase effectiveness. The present invention represents a departure from the prior art in that the method of the present invention allows for total targeted ablation of carious areas not readily visible to the naked eye, while simultaneously utilizing innate resistance and reflective capability of healthy, hard tooth tissue to avoid unnecessary ablation.

### SUMMARY OF THE INVENTION

In view of the foregoing disadvantages inherent in the known methods of caries treatment, this invention provides a targeted method of caries treatment that more efficiently focuses on and destroys decayed and infected tissue. As such, the present invention's general purpose is to provide a new and improved method of caries treatment that is safe and effective to use, while being simultaneously efficient.

To accomplish these objectives, the method comprises selecting a dye which has an absorption spectrum complimentary with the wavelength of a user's laser. The laser, or some other means, is used to preliminarily excavate a caries site, then the site is flushed with the dye to stain areas with residual caries. Finally, after excess dye has been removed by rinsing, the laser is used to destroy stained areas and remove compromised tissue with greater effectiveness.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIGS. 1 through 17 are graphs of absorption spectra, depicting absorption intensity over light wavelength of sample stains, each figure and stain being listed below.

FIG. 1 is an absorption spectrum graph of amaranth.

FIG. 2 is an absorption spectrum graph of 8-anilinonaphthalene-1-sulfonic acid ammonium salt.

FIG. 3 is an absorption spectrum graph of bromophenol red (ph7).

FIG. 4 is an absorption spectrum graph of cresol red.

FIG. 5 is an absorption spectrum graph of 2, 7 dichlorofluroescein.

FIG. 6 is an absorption spectrum graph of eosin 4-isothiocyanate.

FIG. 7 is an absorption spectrum graph of eosin Y.

FIG. 8 is an absorption spectrum graph of FD&C Blue #1.

FIG. 9 is an absorption spectrum graph of FD&C Green #3.

FIG. 10 is an absorption spectrum graph of FD&C Yellow #5 (Tartrazine).

FIG. 11 is an absorption spectrum graph of methylene blue.

FIG. 12 is an absorption spectrum graph of naphthol blue black.

FIG. 13 is an absorption spectrum graph of nigrosin.

FIG. 14 is an absorption spectrum graph of neutral red.

FIG. 15 is an absorption spectrum graph of safranine O.

FIG. 16 is an absorption spectrum graph of thymol blue.

FIG. 17 is an absorption spectrum graph of xylenol blue.

### DEFINITIONS USED IN THE SPECIFICATION

As used in this Application, the term “carbonize” shall mean “to apply energy to organic matter until it turns into carbon and/or oxides resulting from combustion.” The term “vaporize” shall mean “to convert an object or compound into vapor.” All three processes will occur in a tumor or tissue subjected to the methods described in this Application and this Application specifically and exclusively deals with the destruction of undesired tissue through these processes. Accordingly, as used in this Application, the term “destroy”, then, shall mean “destroy through carbonization and/or vaporization. This definition shall be to the exclusion of any other methods of destruction.

This Application shall use the term “stain” to include all such dyes, pigments and stains and any compound or solution utilizing such dye, pigment or stain as an ingredient in its combined whole. The use of the term “stain” is to be understood to include such “stains” that include a pigment or dye as its only ingredient.

The Application specifically deals with the destruction of unwanted or diseased tissue. “Tissue” shall be defined as an aggregate of similar cells and cell products forming a definite kind of structural material with a specific function, in a multi-cellular organism. “Dental Tissue” then shall mean tissues involving the structure of teeth.

These definitions are used throughout this entire Specification and the appended claims.

### DETAILED DESCRIPTION OF THE PREFERRED EMBODIMENT

With reference now to the drawings, the preferred embodiment of the method is herein described. It should be noted that the articles “a”, “an” and “the”, as used in this specification, include plural referents unless the content clearly dictates otherwise.

A caries site is identified through known methods, which could include visual and physical inspection and/or radiographic identification, and prepped. An initial excavation is then performed, using the tools of a practitioner's choice (drills, lasers, sand-blasting, etc). Upon finishing the preliminary excavation, usually when no caries discoloration remains, the site is flushed with an identification stain which has an absorption spectrum that is complimentary with the practitioner's laser tool. By complimentary, this Application means that the absorption spectrum will have an absorption peak (λₘₐₓ) at the emitted wavelength of the laser tool, at least proximately if not exactly. The nature of caries infection is such that bacteria decay and break down tooth enamel and dentin. The bacteria tend to burrow into these tissues, leaving them more porous than healthy hard tissue. The dye then permeates the diseased hard tissue through capillary attraction while leaving healthy hard tissue unaffected. After remaining dye is removed by rinsing, the laser is used to destroy the diseased and compromised tissue and remove it. The dye then not only serves as a visual guide for the practitioner, but also readily absorbs the laser energy and contributes to the destruction process. Healthy hard tissue will minimally absorb the dye and will actually exhibit a reflectance to the laser, in comparison to the compromised, dyed, tissue. This natural factor aids in targeting the tissue to be removed and avoiding healthy hard tissue. After the stained tissue is destroyed, the practitioner will then etch the area with an acid etch to remove residual inorganic material. The acid etch is already a part of the prior art restoration procedure to prepare the site for an adhesive by removing smear layer. Destruction through this method will remove all organic material and leave the remaining inorganic material in a structurally weakened state that is readily susceptible to the acid etching. In this method, the acid etch performs the described secondary duty of removing remaining mineral matrix. The practitioner may then repeat the process for further identification and elimination. After the practitioner is satisfied that the site has been properly excavated, the site is then re-filled with substitute material.

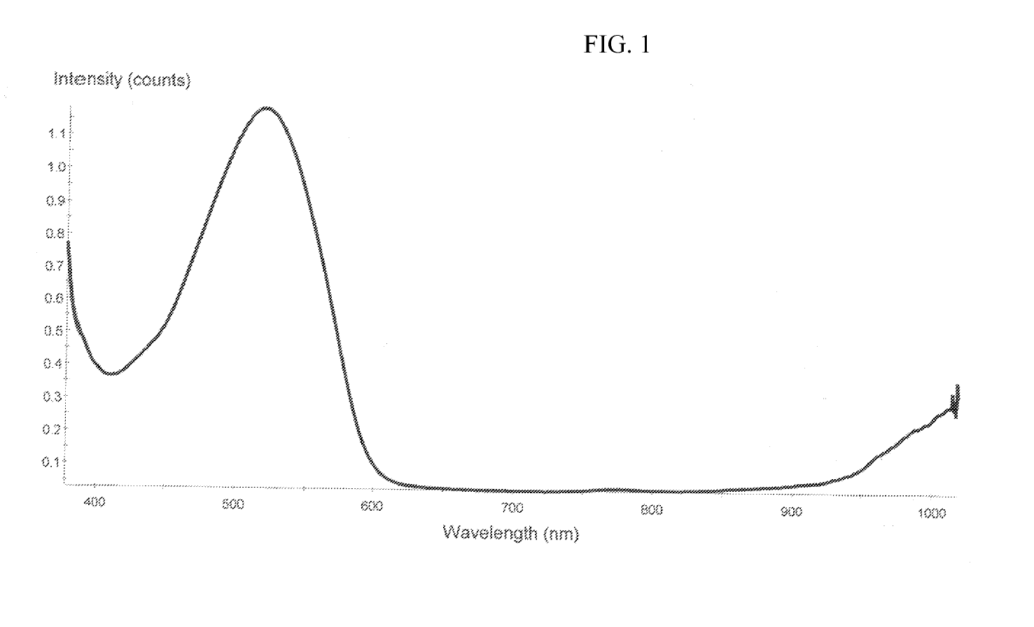

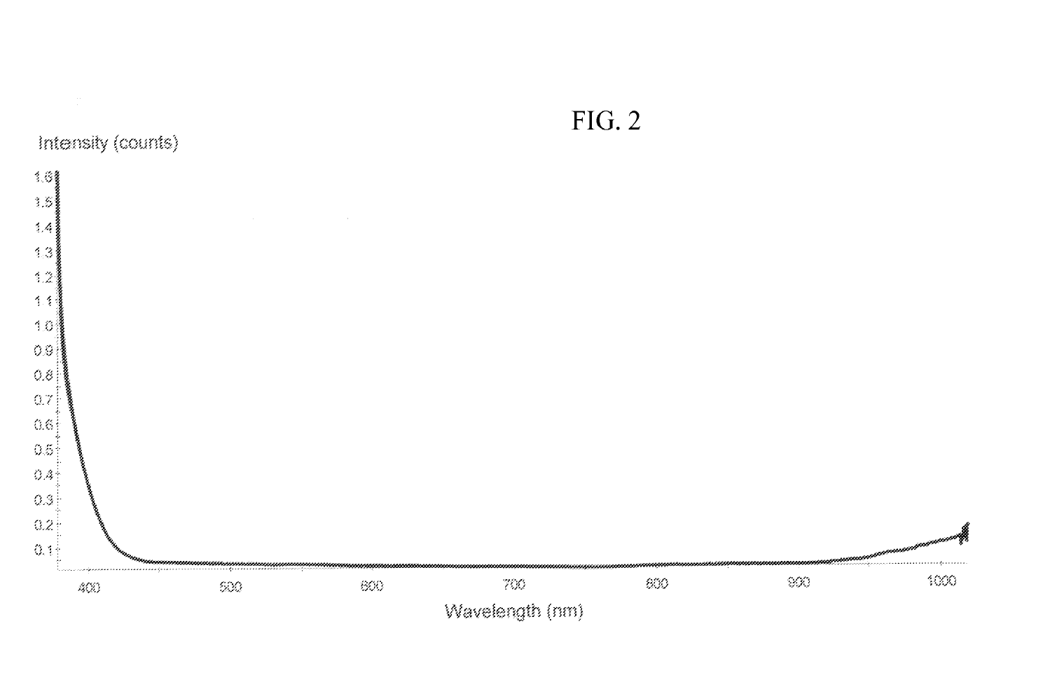

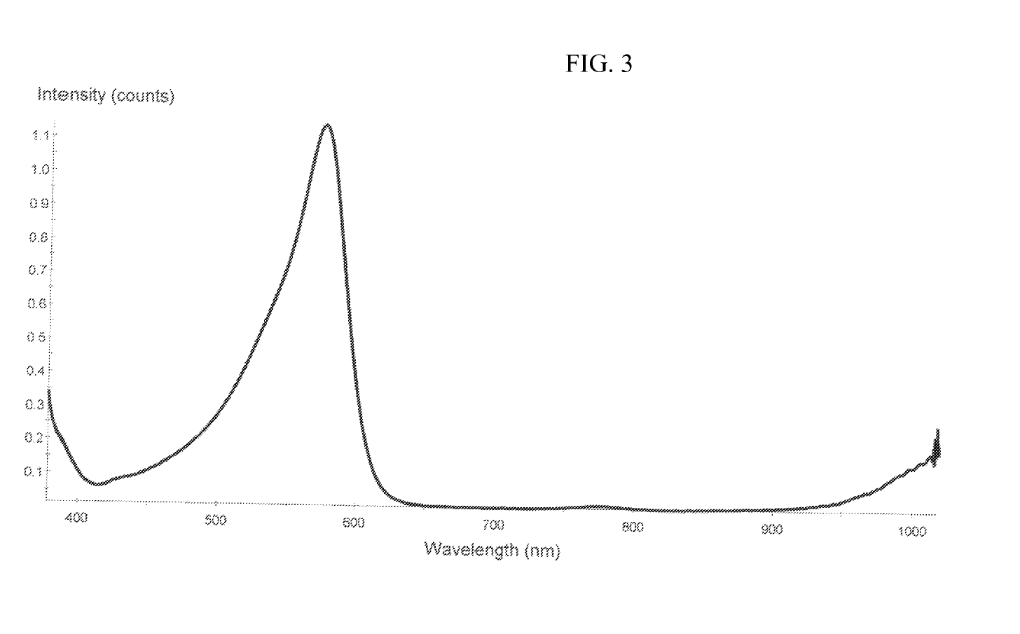

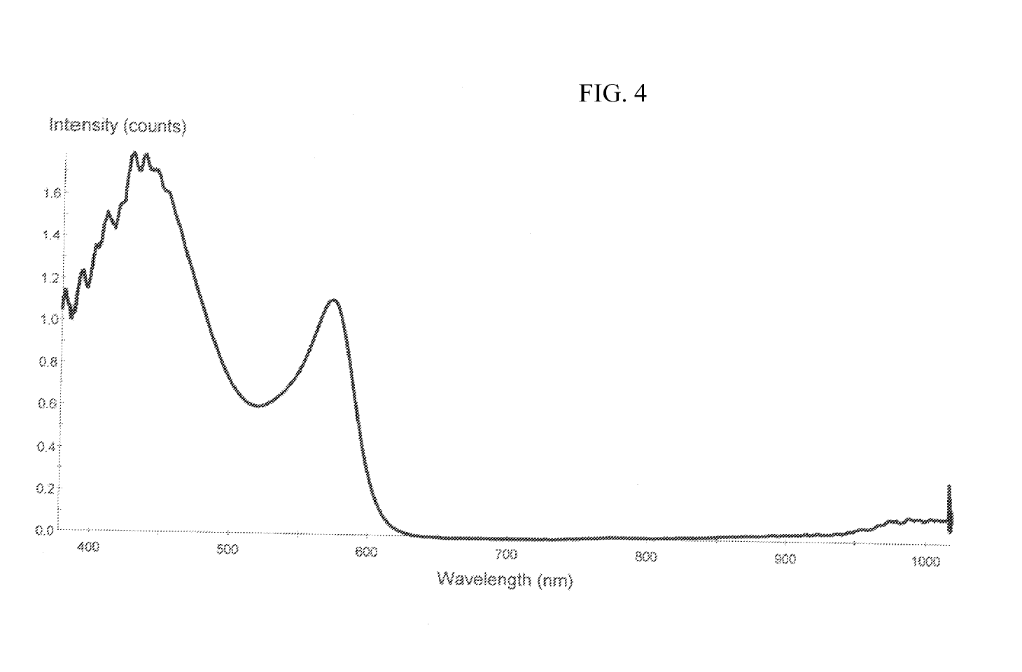

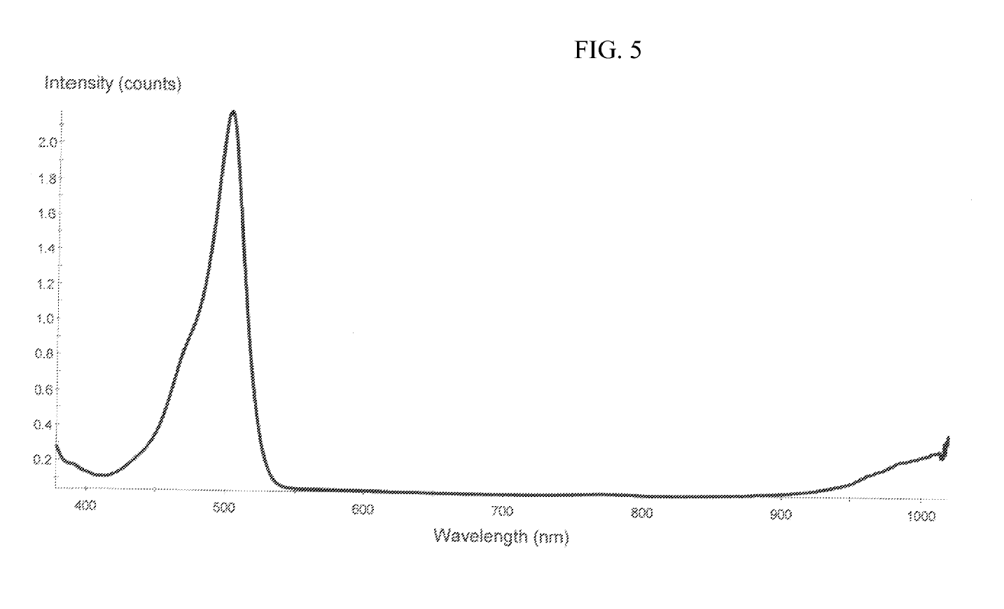

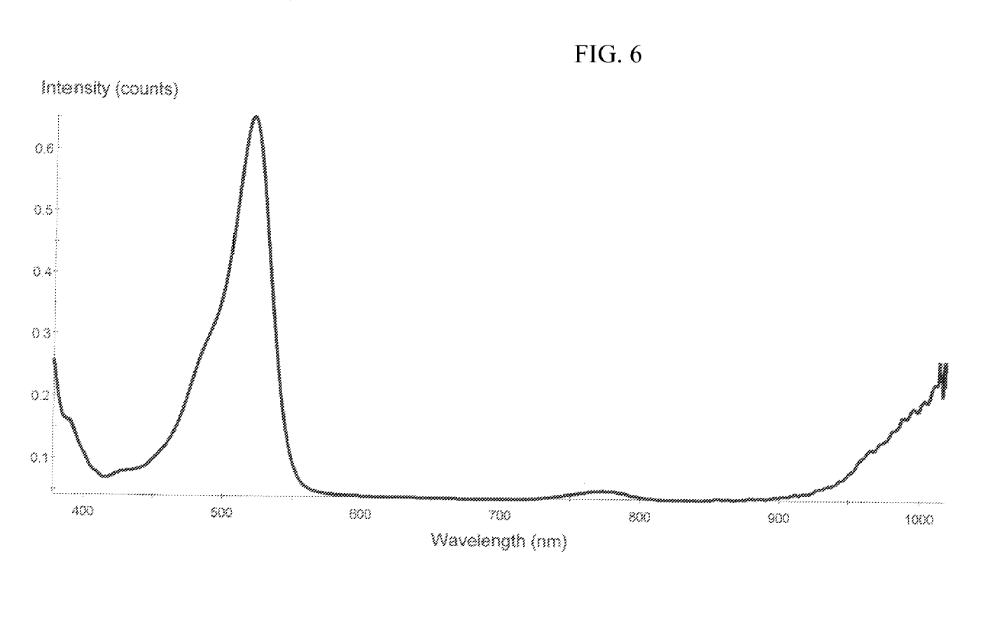

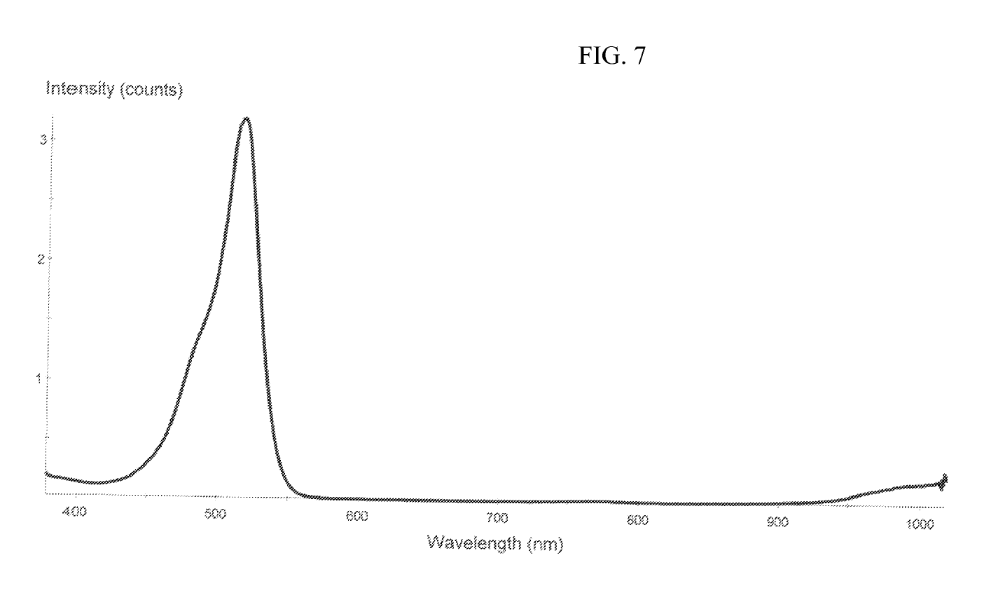

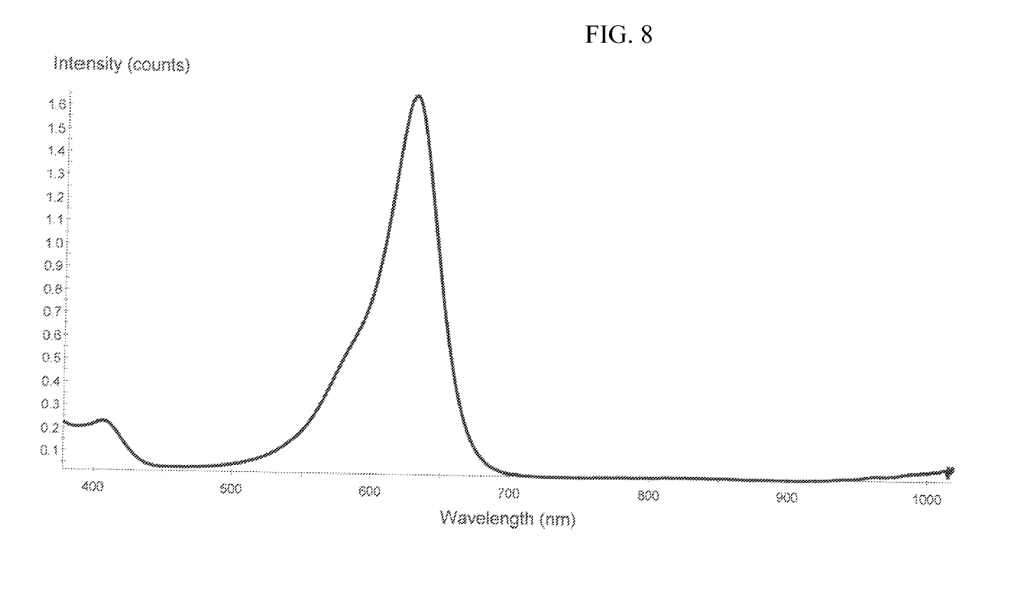

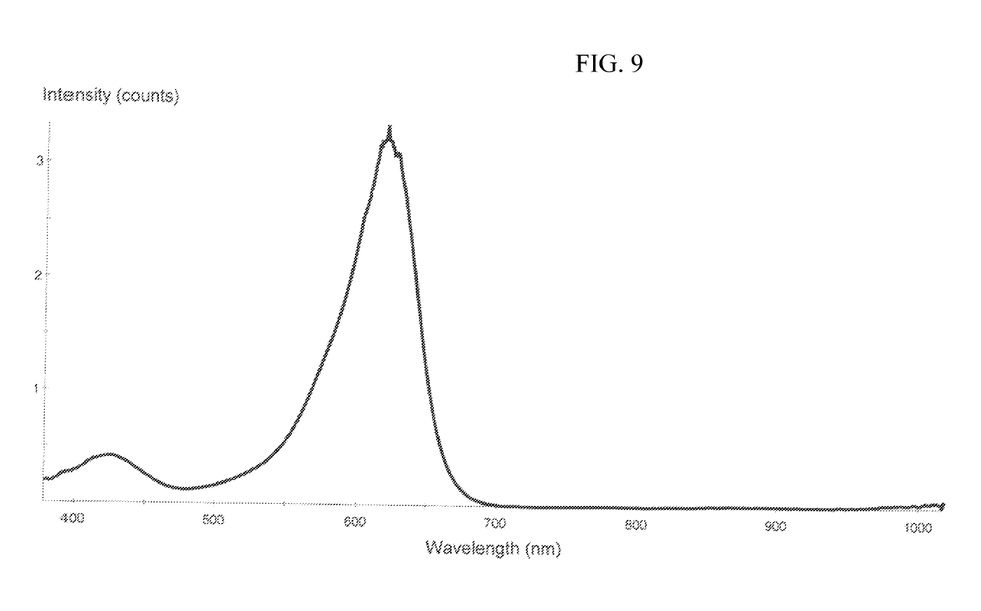

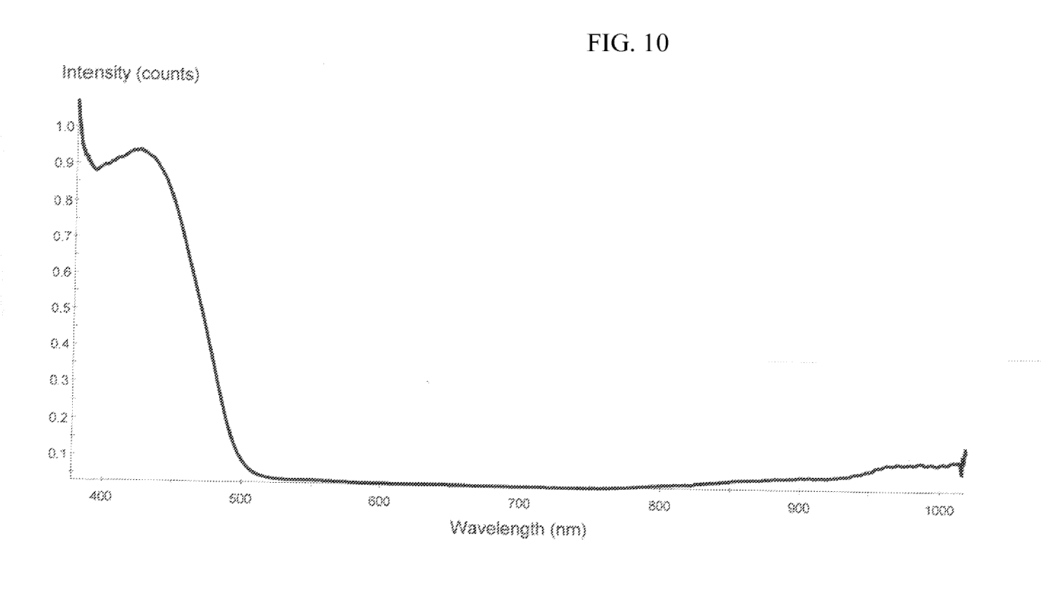

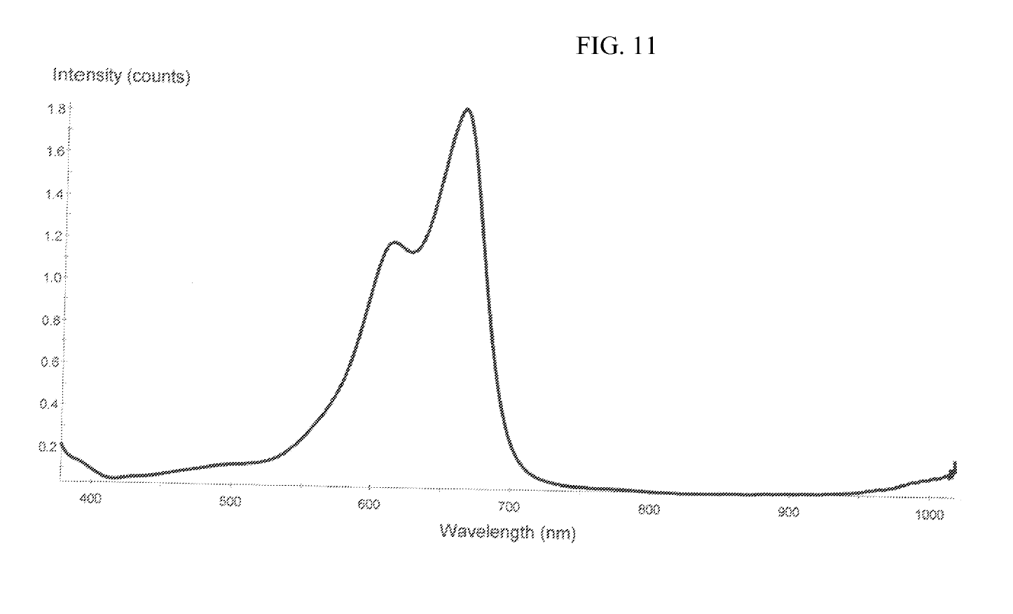

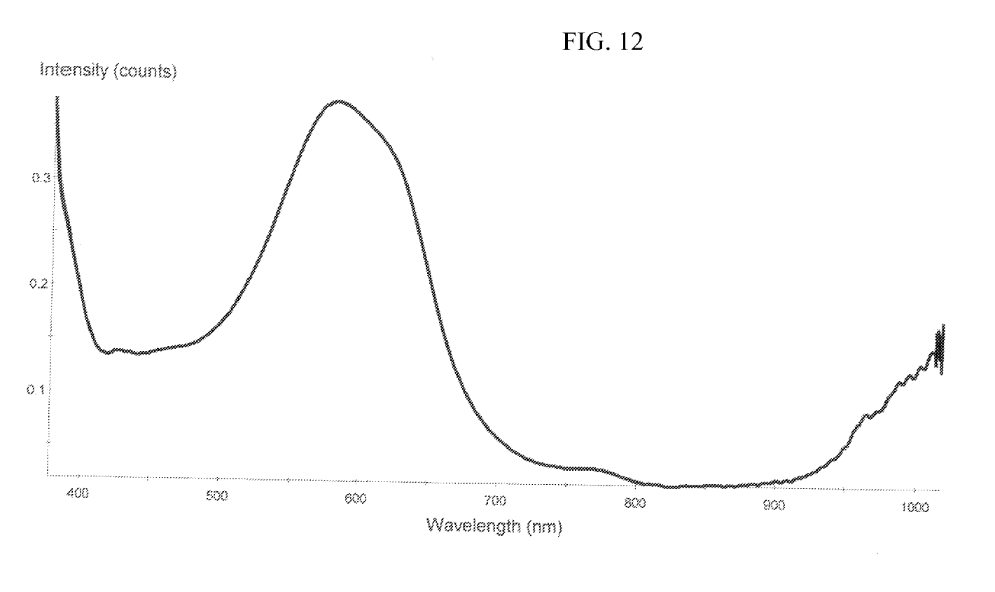

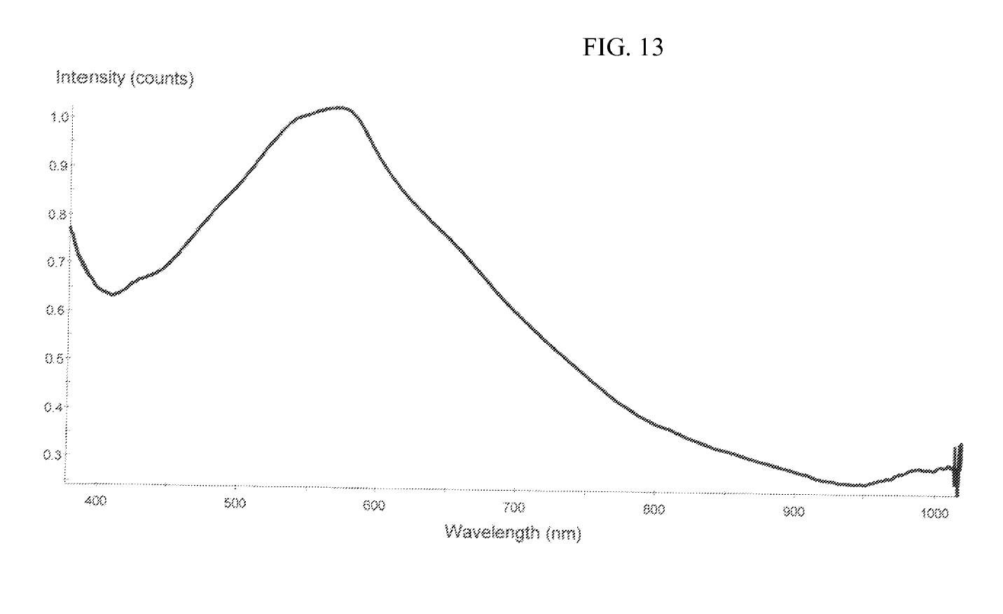

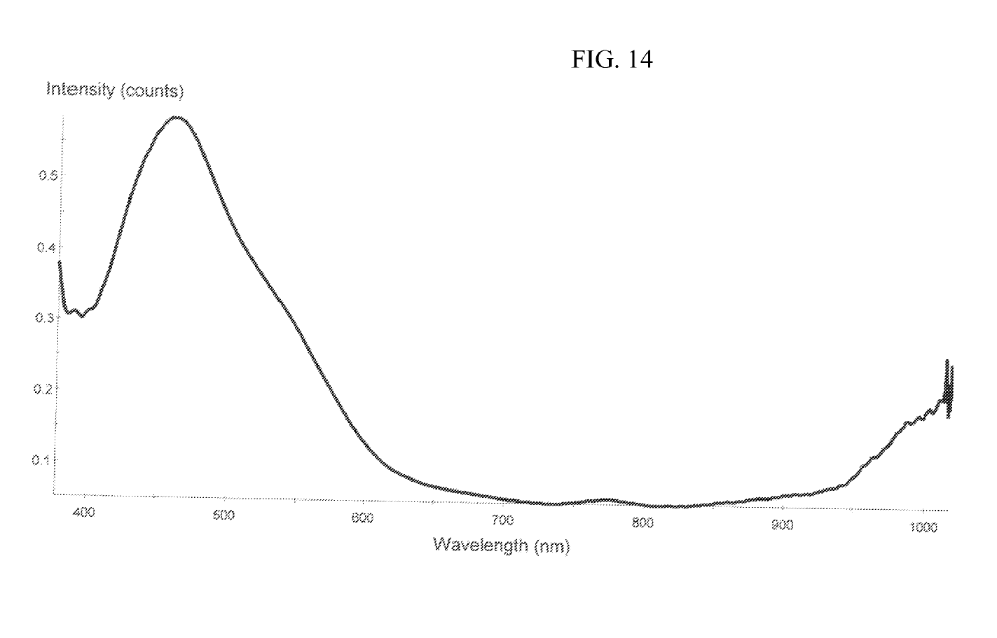

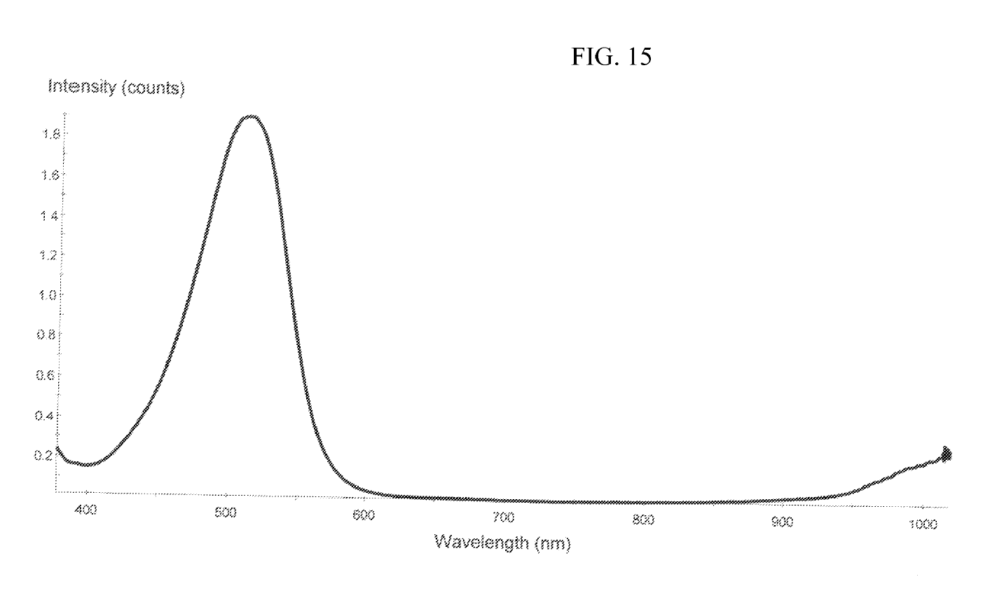

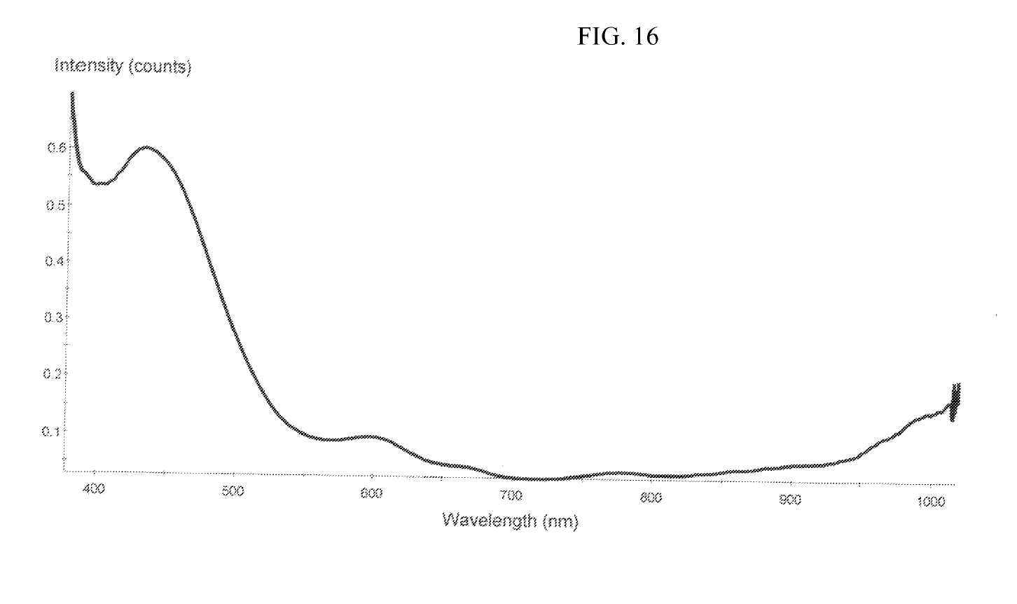

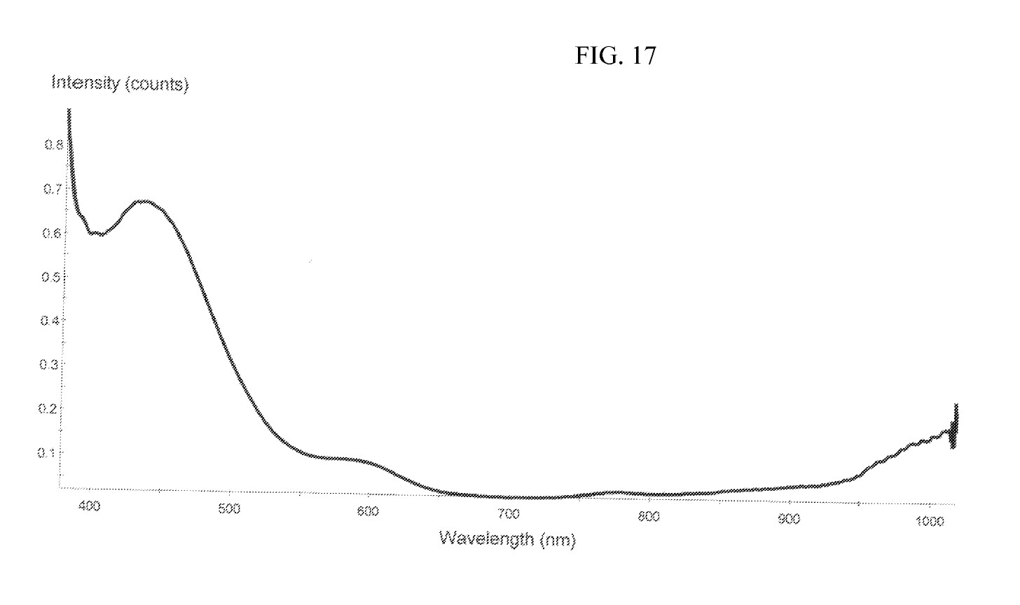

FIGS. 1-17 are examples of absorption spectra of various stains that could be used in the disclosed method. Comparing absorption spectra with the wavelength of a radiant energy source permits matching the source and stain for an efficient caries treatment system and method. As shown in FIG. 1, the absorption spectrum for amaranth peaks at a wavelength of approximately 510 nm. Therefore, the use of a radiant energy source that has an energy output of 510 nm with the dye amaranth would be in accordance with the method herein disclosed. Likewise, FIGS. 2 through 17 are the spectra for sixteen other stains, each having at least one λₘₐₓ and each may be utilized with an energy source with an output having a wavelength corresponding to a given stain's λₘₐₓ.

In a particular example of the practice of this method, it should be noted that diode lasers are capable of emitting energy with a wavelength of 810 nm. Indocyanine green, a particular stain that has been used extensively in other, unrelated, medical applications, has a λₘₐₓ of approximately 810 nm. The use of indocyanine green as an enhancing stain to aid in procedures where the practitioner uses a diode laser is firmly within the teachings of this method.

The method includes staining a selected tissue with a stain that is attuned to absorb the energy from a radiant energy source. The stain enhances absorption of incoming radiant energy, which results in increased destruction of stained tissues and the lessening of destruction of the column of tissues underneath and around the stained tissue. This method allows biological tissues to be destroyed by various strategies. Here, radiant energy can be concentrated to a degree as to totally annihilate a targeted biological tissue.

The stain can be comprised of any substance with the ability to absorb or accept electromagnetic radiation from any radiant energy source. There are literally thousands of dyes, stains and pigments that are commercially available and could be used with the disclosed methods. A few examples of such dyes stains and pigments that may be used individually or as an ingredient in a staining compound include, but are not limited to, are: carbon black, FD&C Blue #2, nigrosin, FD&C black shade, FD&C blue #1, methylene blue, FD&C blue #2, malachite green, D&C green #8, D&C green #6, D&C green #5, ethyl violet, methyl violet, FD&C green #3, FD&C red #3, 5 FD&C red #40, D&C yellow #8, D&C yellow #10, D&C yellow # 11, FD&C yellow #5, FD&C yellow #6, neutral red, safranine 0, FD&C carmine, rhodamine G, napthol blue black, D&C orange #4, thymol blue, auramine 0, D&C red #22, D&C red #6, xylenol blue, chrysoidine Y, D&C red #4, sudan black B, D&C violet #2, D&C red #33, cresol red, fluorescein, fluorescein isothiocyanate, bromophenol red, D&C red #28, D&C red #17, amaranth, methyl salicylate, eosin Y, lucifer yellow, thymol, dibutyl phthalate, indocyanine green, and the like. The preferred stain is one that is generally deemed biologically compatible or non-toxic and may include any of the above dyes, pigments and stains as an ingredient in a final solution used as a stain. Other stains, currently existing or discovered or manufactured in the future, may be readily utilized in this method. Therefore, the above listing should not be considered definitive, but rather illustrative of stains to be utilized in the disclosed method and in no way be considered limiting.

One method of applying the stains to biological tissues to be cut or destroyed can be performed by placement of either a powdered or a liquid form directly on the tissues. This can be done by spreading or smearing a dried powder with a flat instrument over the biological tissue to be treated. The soluble stains can be dissolved in a solvent such as water, glycerin, propylene glycol, mineral oil, ethanol, acetone, polysorbate 80, or any like solvent. These dissolved stains can be applied to biological tissues by means of a brush, a syringe, a bottle, a pen, a cotton pellet, or any fibrous material. Some stains may be a liquid without being dissolved by a solvent; these may also be applied by means of a brush, a cotton pellet, a syringe, a bottle, a pen, or any fibrous material. These stains may optionally contain an anesthetic such as lidocaine, benzocaine, or any local or systemic anesthetic that would aid in alleviating any pain or discomfort caused by the procedure. These stains can be formulated into various compositions to best fit a dental procedure, examples of which are presented below:

Example Formula #1
100%—nigrosin

Example Formula #2
1%—nigrosin
99%—water

Example Formula #3
100%—FD&C Blue #2

Example Formula #4
1.5%—FD&C Blue #2
98.5%—water

Example Formula #5
0.1%—FD&C Blue #2
30%—ethanol
69.9%—Water

Example Formula #6
1%—FD&C Green #3
30%—ethanol
69%—Water

Example Formula #7
2%—Cresol red
98%—ethanol

Example Formula #8
0.5%—amaranth
10%—ethanol
89.5%—glycerol

Example Formula #9
100% Amaranth

Example Formula #10
1%—Eosin 4-isothiocyanate
25%—Polyethylene glycol 600
74%—ethanol

Example Formula #11
99%—Bromophenol Red
1%—Water

Example Formula #12
1.0%—FD&C Yellow #5
99%—Glycerol

Example Formula #13
3%—FD&C Blue #2
10%—polysorbate 80
87%—Water

Example Formula #14
5%—Indocyanine Green
95%—Water

The above example formulas are all able to adequately stain biological tissue. The methods for cutting or destroying tissue warrant use of a radiant energy source with sufficient energy to destroy biological tissue. The radiant energy can be produced from sources such as high intensity light from incandescent, halogen or plasma arc devices. The radiant energy can be produced from sources such as solid-state lasers, examples of which are neodymium YAG, titanium sapphire, thulium YAG, ytterbium YAG, Ruby, holmium YAG lasers and the like. The radiant energy can be produced from sources such as EB or electron beam devices. The radiant energy can be produced from sources such as gas lasers, examples of which are the Carbon dioxide laser, argon gas, xenon gas, nitrogen gas, helium-neon gas, carbon monoxide gas, hydrogen fluoride gas lasers and the like. The radiant energy can be produced from sources such as a diode laser, examples of which are the gallium nitride, aluminum gallium arsenide diode laser and the like. There are also many dye lasers that utilize a radiant energy source that pass through various stains to achieve various wavelengths. Dye lasers are also within the scope of this method. Any wavelength of radiant energy, from 200 nm to 8,000 nm, may be utilized so long as a proper stain is found to match the wavelength emitted by the emitting source.

The method can include use of a radiant energy opaque substance that can be applied around the stained treatment area to protect against incidental or accidental exposure of harmful radiant energy during treatment. A typical procedure would begin by staining the area to be treated with a stain that is attuned to absorb the light from a radiant energy source, followed by covering the surrounding area with a substance that reflects or is opaque to the incoming radiant energy being produced. This combined procedure allows for targeted or selective destruction of biological tissues. The procedure allows the clinician to destroy precisely the biological tissues selected and keep intact those tissues that are intended to remain. A radiant energy opaque substance can be one that reflects most radiant energy and of a substance that is not combustible, for example, inorganic compounds that do not readily combine with atmospheric gases at elevated temperatures. Examples of radiant energy opaque substances are titanium dioxide, zinc oxide, calcium carbonate, and the like. Typically, radiant energy opaque substances are usually visibly white in color.

A method of applying the radiant energy opaque substance to biological tissues can be done by placement of the powdered form directly on the tissues. This can be done by spreading or smearing a dried powder with a flat instrument over the biological tissue to be treated. These substances can be blended in water to form a paste. These opaque suspensions can be applied to biological tissues by means of a brush, a flat instrument, a cotton pellet, a syringe, or any fibrous material. The paste can also contain a suspending aid to avoid settling of solids over time. Examples of suspending aids are sodium carboxy methylcellulose, fumed silica, sodium carboxy ethyl cellulose, precipitated silica, guar gum, and the like.

Radiant energy opaque substances can be formulated into various compositions to best fit a medical, veterinary, or dental procedure, an example of which is presented below:

Example Formula #1b
50%—powdered titanium dioxide
1%—sodium carboxy methyl cellulose
49%—water
   The above example formula would be recognized as adequately able to cover and protect biological tissue from incidental harmful radiant energy.

Another variation of this method is to apply an oxidizing substance to the targeted area before use of the laser. An oxidizing substance is any substance that releases oxygen upon decomposition. The substance decomposes and releases oxygen into the immediately surrounding environment, thereby enhancing the destruction of the targeted tissue. The substance may be applied in addition to the stain or may be a component ingredient of the stain if maintained in a stable form. Oxidizing substances may be organic or inorganic. Potential oxidizing substances that may be utilized in this method include: benzoyl peroxide, T-butyl peroxide, T-butyl peroxide benzoate, potassium nitrate, potassium nitrite, potassium chlorate, potassium chlorite, sodium nitrate, sodium nitrite, sodium chlorate, and sodium chlorite. It should be noted, however, that the use of certain stains, such as indocyanine green, may be so efficient as to render the addition of an oxidizing substance superfluous.

In conceptual testing, a radiant energy source was selected for its ability to adjust output wattage settings nearest those used for soft tissue surgery. The 810 nm Odyssey®NAVIGATOR™ Diode laser from Ivoclar/Vivodent, Inc. was used for this study because of the variable controls and the ease of disposable tips. The laser was set to continuous mode throughout the study. The laser hand piece was mounted onto an adjustable laboratory clamp/stand in order to control the constant tip distance to the soft tissue. A steel pre-measured gauge of 1.5 mm thickness was used to ensure the tip distance was as near a consistency of 1.5 mm from the soft tissue as possible. The soft tissue used in this study was pork loin, which was intended to closely mimic human tissue. The wattage settings used in the test were 0.1, 0.2, 0.3, 0.4, 0.5, 1.0, 2.0, and 3.0. A total of 5 stain groups were selected as test groups: no stain (control group) and FD&C Green #3, FD&C Blue #2, Indocyanine green, and Carbon black. A maximum of 1 minute was selected as the duration of time to determine the carbonization treatment window. The criterion to measure whether the soft tissue achieves a state of carbonization was to examine the time it takes for a gray to black dot to form immediately beneath a weak aiming beam. The study considers the formation of the usual black or gray spots as evidence of carbonization and/or combustion. The formation of a gray to black dot or spot is considered a positive test and the time of initiation is noted. The formation of no spot or dot is a negative test or none formed.

The experiment in general consisted of laying a fairly flat piece of pork loin on a flat surface and positioning the laser tip with the aid of the steel gauge to about 1.5 mm from the surface. To the pork loin was then applied a coat of the various stains and subsequently irradiated at the various power settings until carbonization was achieved or 1 minute of time elapsed. The time was controlled with a stopwatch. The following table presents the results:

| | | | FD&C | | |
|---|---|---|---|---|---|
| | No Stain | FD&C | Blue | Indocyanine | Carbon |
| | (control) | green #3 | #2 | Green (ICG) | Black |
| 0.1 Watt | No | NC | NC | NC | NC |
| | Carbonization | | | | |
| | (“NC”) | | | | |
| 0.2 Watt | NC | NC | NC | NC | NC |
| 0.3 Watt | NC | NC | NC | NC | 58 sec |
| 0.4 Watt | NC | NC | NC | 47 sec | 26 sec |
| 0.5 Watt | NC | NC | NC | 21 sec | 11 sec |
| 1.0 Watt | NC | NC | NC | 5 sec | 1 sec |
| 2.0 Watt | NC | NC | NC | 2 sec | 1 sec |
| 3.0 Watt | NC | NC | NC | 1 sec | 1 sec |

The stains were chosen for their various absorption efficiencies with respect to a λₘₐₓ of 810 nm. The absorption efficiency is merely a percentage of energy absorbed by the stained tissue with respect to energy output. Carbon black was selected as a universal stain with absorption efficiencies above 95% over a wide range of wavelengths; as can be seen from the data how effective it was over the control. Indocyanine Green was selected for its known λₘₐₓ near 810 nm and has absorption efficiency greater than about 90%; it also allowed carbonization of soft tissue at a much lower wattage than an unmatched stain and/or control groups. FD&C Blue #2 was selected for its minimal absorption characteristics at 810 nm, with only about a 30% efficiency it did no better than the control, though it would in theory initiate carbonization sooner than the control at higher wattages. FD&C green #3 was selected because it had insignificant absorption efficiency at 810 nm and as demonstrated—did no better than the control.

The data demonstrates that when the absorption characteristics of a stain are matched to the wavelength of a radiant energy source, the power output required to initiate carbonization is significantly reduced. Carbon black initiated carbonization with as little as 0.3 watts at a distance of 1.5 mm from the pork loin. On the other hand, the control did not initiate carbonization at 3.0 watts at 1.5 mm. This study shows that it is possible to paint any given tissue, regardless of the absorption characteristics of said tissue and carbonize said tissue selectively and at a much lower wattage. It also demonstrates that at these lower wattage settings, unstained tissue will be unharmed by the radiant energy.

An actual in vivo clinical test recently performed confirmed the efficacy of the present invention. In the test, a laser source emitting laser energy having a wavelength of about 810 nm and a power level of about 5 W was used to expose a cancerous tumor having a volume about 9 mm in diameter to laser energy for about 5 minutes. Necrosis of the tumor began after about 1 minute of exposure, and the tumor was substantially destroyed after about 5 minutes, resulting in destruction of all or substantially all of the cancerous cells exposed to the laser energy.

Preferred embodiments will depend upon the laser available to a clinician.

However, in each case, the stain should have an absorption efficiency of greater than 90% at the given laser source's λmax. Obviously, the higher the efficiency, the lower power output from the laser source will be necessary and less collateral damage to healthy tissue will occur. As illustrated above, for an 810 nm diode laser, carbon black or indocyanine green may be used. In the case of an absorption efficiency of 95% or greater, only 0.3 W of power may be used as a minimum. At an efficiency of 90% or greater, the power output may be 0.4 W or greater. Stronger power outputs may be used to lessen treatment time and still not affect untreated tissue as illustrated in the conceptual test. Other dyes may be used so long as they have a λₘₐₓ that allows for an absorption efficiency of 90% or greater for a given wavelength of energy. For example, toluidine blue has a λₘₐₓ at 626 nm, so it may be used with a radiant energy source capable of emitting such energy at that wavelength. Bromophenol blue has three λ-maxima, at 383, 422 and 589 nm respectively, and may be used with a corresponding radiant energy source for either of those three maxima. The actual power output should be left to the clinician to determine based on each particular case, as size and location of the targeted tissue will also factor into treatment times and power output. It is possible for treatment times to extend as little as one second or as long as an hour or more depending on the wattage used, size of the tissue, absorption efficiency and other factors. Power may range from 0.1 W, as used in the test outlined above, to 30 W and may modulate.

Although the present invention has been described with reference to preferred embodiments, numerous modifications and variations can be made and still the result will come within the scope of the invention. No limitation with respect to the specific embodiments disclosed herein is intended or should be inferred.

I claim:

1. A method for treating residual caries after initial excavation is completed, said excavation leaving an excavated site, the method comprising:
a. flooding the site with a stain chosen to readily absorb energy emitted from a chosen laser source;
b. allowing some of the stain to be absorbed into compromised hard dental tissue;
c. rinsing the area, leaving the absorbed stain in the compromised hard dental tissue; and
d. destroying the compromised hard dental tissue with the laser until compromised dental organic tissue is removed and remaining residual inorganic tissue is prepared for removal by acid etch.

2. The method of claim 1 being repeated at least once.

3. The method of claim 1, the stain containing at least one ingredient selected from the group of ingredients consisting of: carbon black, FD&C Blue #2, nigrosin, FD&C black shade, FD&C blue #1, methylene blue, FD&C blue #2, malachite green, D&C green #8, D&C green #6, D&C green #5, ethyl violet, methyl violet, FD&C green #3, FD&C red #3, FD&C red #40, D&C yellow #8, D&C yellow #10, D&C yellow # 11, FD&C yellow #5, FD&C yellow #6, neutral red, safranine 0, FD&C carmine, rhodamine G, napthol blue black, D&C orange #4, thymol blue, auramine 0, D&C red #22, D&C red #6, xylenol blue, chrysoidine Y, D&C red #4, sudan black B, D&C violet #2, D&C red #33, cresol red, fluorescein, fluorescein isothiocyanate, bromophenol red, D&C red #28, D&C red #17, amaranth, methyl salicylate, eosin Y, lucifer yellow, thymol, and dibutyl phthalate.

4. The method of claim 3, the stain further comprising an anesthetic.

5. The method of claim 1, the stain being applied to the excavated site by spreading a paste containing the stain over the excavated site.

6. The method of claim 1, the stain being applied to the excavated site by spreading a liquid containing the stain over the excavated site.

7. The method of claim 1, the stain being applied to the excavated site by spreading a powder containing the stain over the excavated site.

8. The method of claim 1, further comprising the step of adding an oxidizing substance to the biological substrate.

9. The method of claim 8, the oxidizing substance being applied as a part of the stain.

10. The method of claim 8, the oxidizing substance being selected from the group of oxidizing substances consisting of: benzoyl peroxide, T-butyl peroxide, T-butyl peroxide benzoate, potassium nitrate, potassium nitrite, potassium chlorate, potassium chlorite, sodium nitrate, sodium nitrite, sodium chlorate, and sodium chlorite.

11. The method of claim 1, further comprising a step of applying a radiant opaque substance to tissues surrounding the biological substrate, wherein said surrounding tissues are then protected from absorbing energy from the radiant source.

12. The method of claim 11, the radiant opaque substance containing at least one ingredient selected from the group of ingredients consisting of: titanium dioxide, zinc oxide, and calcium carbonate.

13. The method of claim 1, further comprising the step of using an acid etch to remove residual inorganic material after ablation.

14. The method of claim 1, wherein the stain has an absorption efficiency to the radiation energy higher than 80%.

15. The method of claim 1, the radiant energy emitted having a wavelength in the range from about 200 nm to about 8,000 nm.

16. The method of claim 1, wherein the laser system operating at a power level of at least 0.3 Watts.

17. The method of claim 1, wherein the laser system is selected from the group consisting of semiconductor lasers, solid state lasers, and gas lasers.

18. The method of claim 1, wherein the laser system emits radiant energy of a modulating power level in the range of from 0.1 watt to 30 watts.

19. The method of claim 1, wherein the tissue is exposed to the laser light for a time duration that is within the range of from about 1 second to about 1 hour.

20. The method of claim 1, the stain being indocyanine green and the laser source being a laser emitting radiant energy at about 810 nm.
